(19) United States
(12) Patent Application Publication
(10) Pub. No.: US 2009/0219830 A1
(43) Pub. Date: Sep. 3, 2009

(54) THIN DESKTOP LOCAL AREA NETWORK SWITCH

(75) Inventors: Kenneth E. Venner, Las Flores, CA (US); Umer Khan, Irvine, CA (US)

Correspondence Address: FIALA & WEAVER, P.L.L.C.;C/O CPA GLOBAL, P.O. BOX 52050, MINNEAPOLIS, MN, 55402, US

(73) Assignee: BROADCOM CORPORATION, Irvine, CA (US)

(21) Appl. No.: 12/039,938

(22) Filed: Feb. 29, 2008

(51) Int. Cl. H04L 12/28

(52) U.S. Cl. 370/254

(57) ABSTRACT

Methods, systems, and apparatuses for an automatically configured network switch are provided. The network switch includes a plurality of ports, a switch fabric, switch control logic, and a switch configuration module. The ports are configured to be coupled to a plurality of network communication links. The switch fabric is coupled to each of the ports, providing interconnections between the ports. The switch control logic is coupled to the switch fabric to provide data path selection and arbitration. The switch configuration module is configured to generate a request for switch configuration information to be transmitted from one or more ports of the switch, over the network, to a switch management server. The switch control logic is configured to configure one or more features of the network switch to operate according to the received configuration information.

### BACKGROUND OF THE INVENTION

1. Field of the Invention

The present invention relates to computer network switches.

2. Background Art

A computer network is an interconnection of computing devices, such as personal computers, servers, and/or further types of computing devices. A network may include one or more networking devices, such as bridges, hubs, switches, and routers, which interconnect nodes of the network. Communications in a computer network typically take place in the form of streams of data packets. Networking devices receive data packets transmitted from computing devices, and retransmit the data packets over links of the network so that they reach their intended destinations. Switches (which generally encompass bridges and routers) analyze each data packet received from the network to determine a source device and destination device, and forward the data packet to the appropriate destination device.

Switches may be categorized into two categories: unmanaged switches and managed switches. An unmanaged switch does not have a configuration interface or configurable features. Thus, unmanaged switches may be used for purely for switching functions, but are not flexible in functionality, and do not include monitoring functionality. Managed switches have a configuration interface that a system administrator can use to configure features of the managed switch. For example, managed switches may provide a configuration interface in the form of command-line access via TELNET and SSH (secure shell), though SNMP (simple network management protocol), a Web interface, or other means such as web services, APIs (application programming interfaces), etc. Through the configuration interface, the system administrator can set port priorities, monitor device and link health, configure network access options, and/or perform further configuration functions.

Some computing environments, such as medium and large enterprise environments, may include computer networks having very large numbers of networking devices. For instance, some computer networks may include hundreds and even thousands of network switches to interconnect large numbers of computing devices. Such computer networks may have very complex topologies. As a result, an ability to configure and monitor the computer network is important. Managed switches, which do provide configurability and enable network monitoring, are relatively expensive. Furthermore, it can be extremely burdensome on an IT department to be maintaining configurations of thousands of managed switches. Unmanaged switches, while relatively inexpensive, do not provide for configurability or network monitoring.

Thus, what are needed are improved switching devices that provide greater functionality while reducing an administration burden. Such switching devices may be especially useful replacements for smaller switches that are often deployed in conference rooms, cubicles, etc.

### BRIEF SUMMARY OF THE INVENTION

Methods, systems, and apparatuses for an automatically configurable network switch are provided. For instance, the network switch may enter a self-configuration mode after power-up and/or being coupled into a computer network. The network switch configures itself by contacting a remote entity (e.g., a server, another network switch, etc.) for configuration information. The network switch receives the configuration information, and configures itself accordingly.

In an example aspect, a network switch includes a plurality of ports, a switch fabric, switch control logic, and a switch configuration module. The plurality of ports is configured to be coupled to a plurality of network communication links. The switch fabric is coupled to each of the plurality of ports, providing interconnections between the ports. The switch control logic is coupled to the switch fabric to provide data path selection and arbitration for communications signals received at the ports. The switch configuration module is configured to generate a request for switch configuration information to be transmitted from a port of the switch, over the network, to a switch management server. The switch control logic is configured to operate according to the received configuration information.

In an example, the configuration information includes one or more of authentication information, network access control (NAC) information, quality of service (QOS) information, an access list, and VLAN configuration information. The configuration information may include additional and/or alternative types of information for configuring network switches.

In an aspect, the network switch further includes a switch monitor module. The switch monitor module is configured to monitor a status of the network switch, including a status of communication traffic handled by the network switch.

In a further aspect, a method in a network switch is provided. A request is transmitted over the network for a network address for the switch. The network address for the switch is received over the network, as well as a network address for a switch management server. A request is transmitted over the network to the switch management server for switch configuration information. The configuration information is received from the switch management server entity over the network. One or more features of the switch are configured according to the received configuration information.

In a still further aspect, a switch management server is provided. The server includes a switch configuration information provider module configured to receive a request from a switch for configuration information, and to transmit the configuration information to the switch. The switch receives the transmitted configuration information and configures one or more switch features according to the received configuration information.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an example computer network.

FIG. 2 shows a block diagram of a computer network that includes an automatically configurable switch, according to an example embodiment of the present invention.

FIG. 3 shows a flowchart providing example steps for configuring a switch, according to an example embodiment of the present invention.

FIG. 4 shows a block diagram of an automatically configurable switch, according to an example embodiment of the present invention.

FIG. 5 shows a block diagram of the computer network of FIG. 2, where the automatically configurable switch of the computer network is being configured, according to an example embodiment of the present invention.

FIGS. 6 and 7 show block diagrams of example computer networks, according to embodiments of the present invention.

FIG. 8 shows a block diagram of an automatically configurable switch, according to an example embodiment of the present invention.

FIG. 9 shows example configuration information, according to an embodiment of the present invention.

FIG. 10 shows a flowchart providing example steps for enabling a communication signal in a network switch, according to an embodiment of the present invention.

FIG. 11 shows a block diagram of an automatically configurable switch, according to an example embodiment of the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Example Computer Network

Embodiments of the present invention relate to computer networks. A computer network is an interconnection of computing devices. Examples of such computing devices include personal computers, workstations, and servers. Further types of devices may be coupled to a computer network, including printers, telephones, and further electronic devices. A network may include one or more networking devices, such as bridges, hubs, switches, and routers, which interconnect nodes of the network. Communications over a network typically take place in the form of streams of data packets (e.g., Internet Protocol (IP) packets) transmitted from computing devices. Networking devices in the network receive and retransmit the data packets over links of the network so that they reach their intended destinations. For instance, switches (which generally encompass bridges and routers) analyze each data packet received from the network to determine a source device and destination device, and forward the data packet to the appropriate destination device.

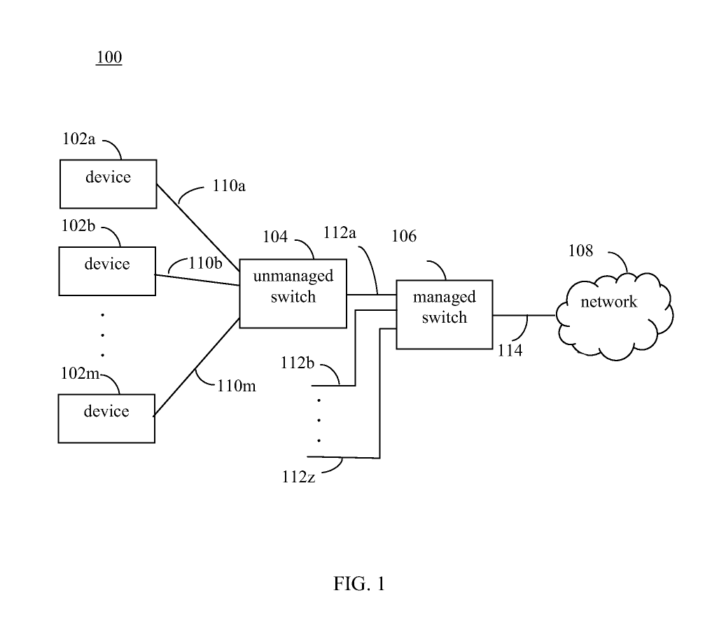

For instance, FIG. 1 shows an example computer network 100. As shown in FIG. 1, a plurality of devices 102a-102m is coupled to a network 108 through an unmanaged switch 104 and a managed switch 106. For example, each device 102 may be a desktop computer, a mobile computer (e.g., laptop computer, handheld computer, personal digital assistant (PDA), appliance, other electronics device such as a television with built-in networking capability, etc.), a server, a workstation, other computing device type, an IP telephone, a printer, or other network-ready device. Devices 102a-102m are each coupled to a respective port of unmanaged switch 104 by one of communication links 110a-110m. Unmanaged switch 104 has another port coupled to a port of managed switch 106 by a communication link 112a. Managed switch 106 may have further ports coupled to additional devices (such as computing devices, networking devices, and/or further device types) by communication links 112b-112z. Managed switch 106 has another port coupled to network 108 by communication link 114. Network 108 may be any type of network, including a local area network (LAN), a wide area network (WAN), or a combination of networks, such as the Internet. Network 108 may include unmanaged switch 104, managed switch 106, and/or any number of further networking devices coupled to any number of further network-ready devices.

Managed switch 106 and unmanaged switch 104 enable devices 102a-102m to communicate with each other and/or with devices associated with network 108 by receiving and retransmitting data packets over communication links 110a-110m, 112a, and 114, as dictated by the particular communication. Any number of devices 102 (e.g., computing devices and/or networking devices) may be present in computer network 100 coupled to unmanaged switch 104, depending on the computing needs of the particular environment, and on the number of ports of unmanaged switch 104. For example, unmanaged switch 104 may be a five port switch to enable unmanaged switch 104 to be connected to four devices 102 and managed switch 106. In a similar manner, any number of devices may be coupled to managed switch 106, depending on the computing needs of the particular environment, and on the number of ports of managed switch 106. For example, managed switch 106 may be a five port switch, an eight port switch, a forty-eight port switch, or any other size of switch.

Unmanaged switch 104 does not have a configuration interface or configurable features. Thus, unmanaged switch 104 may be used for switching functions, but is not flexible, as unmanaged switch 104 cannot be configured. Furthermore, unmanaged switch 104 does not include functionality enabling performance of unmanaged switch 104 to be directly monitored. Managed switch 106 has a configuration interface that a system administrator can use to configure switch features. For example, managed switch 106 may provide a configuration interface in the form of command-line access via TELNET and SSH (secure shell), though SNMP (simple network management protocol), a Web interface, or other means such as web services, APIs, etc. Through the configuration interface, the system administrator can set port priorities, monitor device and link health, configure network access options, and perform further configuration functions for managed switch 106.

In some computing environments, such as medium and large enterprise environments, computer network 100 may include a very large number of networking devices, including having hundreds and even thousands of network switches, to interconnect large numbers of devices 102. As networks become larger, the ability to configure and monitor the network becomes increasingly important. However, while managed switch 106 does provide configurability and enables network monitoring, managed switch is relatively expensive, and it is very burdensome for an IT department to manually maintain configurations of thousands of managed switches 106 in a computer network. Unmanaged switch 104, while relatively less expensive, does not provide configurability or enable network monitoring.

Embodiments of the present invention overcome these deficiencies of conventional switches, providing switches that have configurable features, enable network monitoring, and may be configured at a reduced level of manual effort. Example embodiments of the present invention are described in detail in the following section.

### Example Embodiments

The example embodiments described herein are provided for illustrative purposes, and are not limiting. The examples described herein may be adapted to any type of network. Furthermore, additional structural and operational embodiments, including modifications/alterations, will become apparent to persons skilled in the relevant art(s) from the teachings herein.

In embodiments of the present invention, an automatically configurable switch is provided, which may also be referred to as a “thin” switch. In embodiments, the switch has configurable features similarly to a managed switch. However, as opposed to a conventional managed switch, which requires a system administrator to manually make configuration changes to the managed switch, the automatically configurable switch is automatically configured, such as when the switch is coupled to a network. Thus, the automatically configurable switches are simple to install, similarly to unmanaged switches. Furthermore, many such automatically configurable switches may be installed in a computer network, without requiring as much time and manual effort spent configuring the switches, as opposed to conventional managed switches. In an embodiment, an automatically configurable switch may provide greater functionality, while reducing an administrative burden. The automatically configurable switch may be deployed in any suitable environment. For instance, the automatically configurable switch may be useful for deployment in conference rooms, office cubicles, etc., where smaller switches may be typically used.

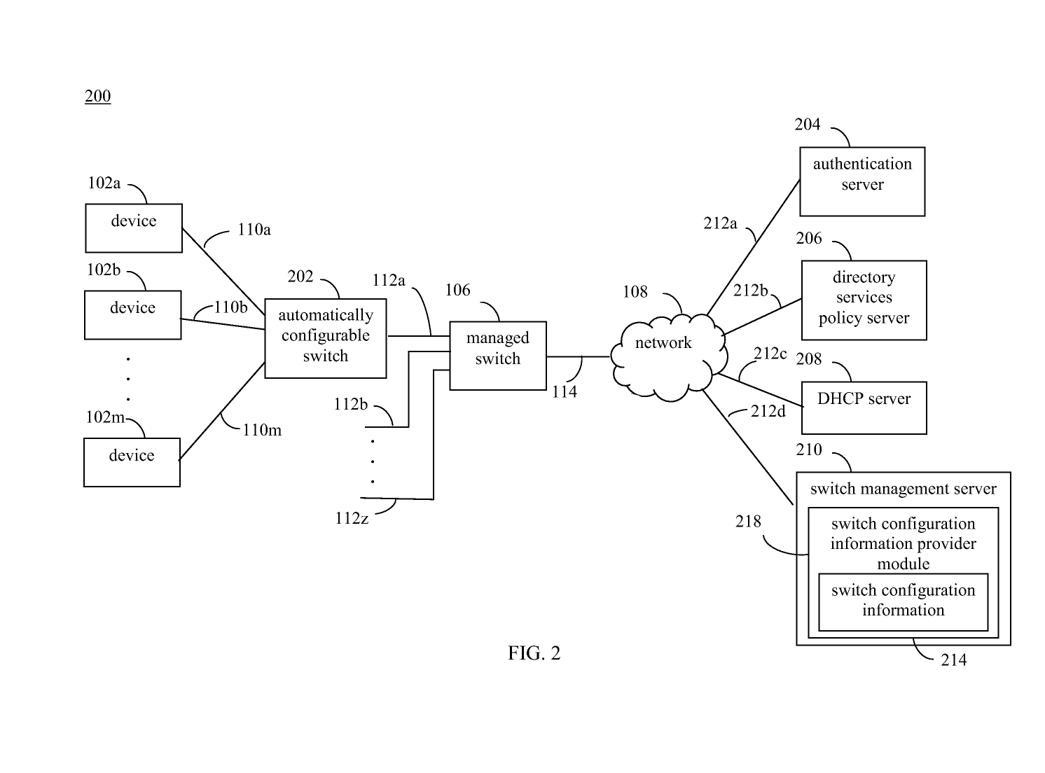

For instance, FIG. 2 shows a computer network 200 that includes an automatically configurable switch (ACS) 202, according to an embodiment of the present invention. As shown in FIG. 2, devices 102a-102m are coupled to network 108 through ACS 202 and managed switch 106. Furthermore, network 200 includes an authentication server 204, a directory services policy server 206, a DHCP (Dynamic Host Configuration Protocol) server 208, and switch management server 210, which are each coupled to network 108 by a respective one of communication links 212a-212d.

Devices 102a-102m are each coupled to a respective port of ACS 202 by one of communication links 110a-110m. ACS 202 has another port coupled to a port of managed switch 106 by communication link 112a. Managed switch 106 may have further ports coupled to additional devices (such as computing devices, networking devices, and/or further device types) by communication links 112b-112z. Managed switch 106 has another port coupled to network 108 by communication link 114.

As described above, network 108 may be any type of network, including a local area network (LAN), a wide area network (WAN), or a combination of networks, such as the Internet. Network 108 may include ACS 202 and managed switch 106, and/or any number of further networking devices coupled to any number of further devices. Communication links 110a-110m, 112a-112z, 114, and 212a-212d may be any type of communication link, wired or wireless, suitable for a computer network. For instance, communication links 110a-110m, 112a-112z, 114, and 212a-212d may be galvanic cables (e.g., Category 5 cable), optical cable (e.g., optical fibers), radio frequency links (e.g., IEEE 802.11 standard), or other type of link. Communication links 110a-110m, 112a-112z, 114, and 212a-212d may be configured as Ethernet links, or according to other networking standard or technique.

Managed switch 106 and ACS 202 enable devices 102a-102m to communicate with each other and/or with devices associated with network 108 by receiving and retransmitting data packets over communication links 110a-110m, 112a-112z, and 114, as dictated by the particular communication. Any number of devices 102 (e.g., computing devices and/or networking devices) may be present in computer network 200 coupled to ACS 202, depending on the computing needs of the particular environment, and on the number of ports of ACS 202. ACS 202 may have any number of ports, including being a five port switch, an eight port switch, a forty-eight port switch, or any other size of switch. ACS 202 is configured to analyze a data packet received on a port to determine the source and destination device of the data packet, and to forward the data packet toward the appropriate device over the corresponding port of ACS 202.

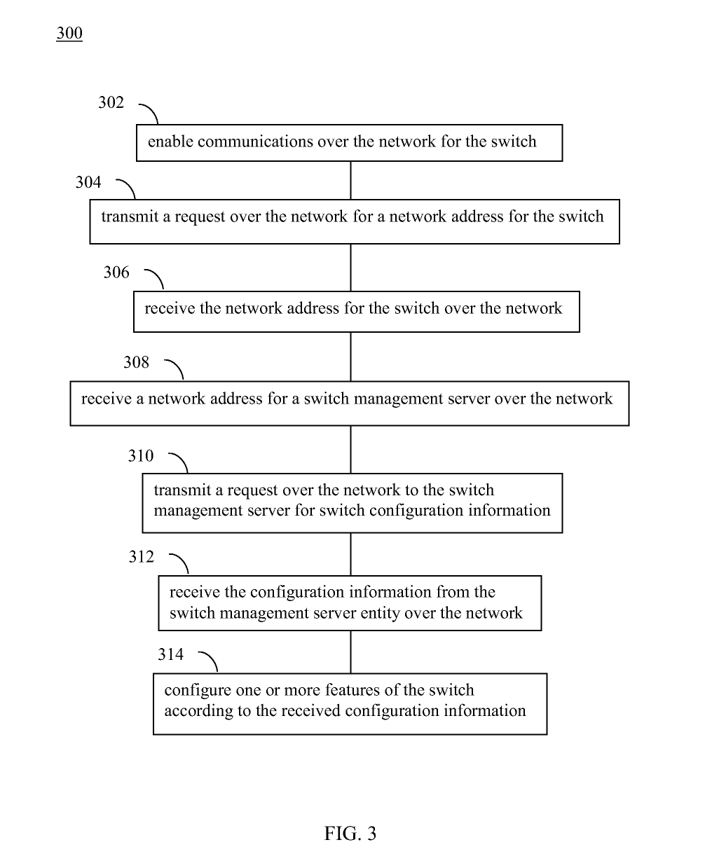

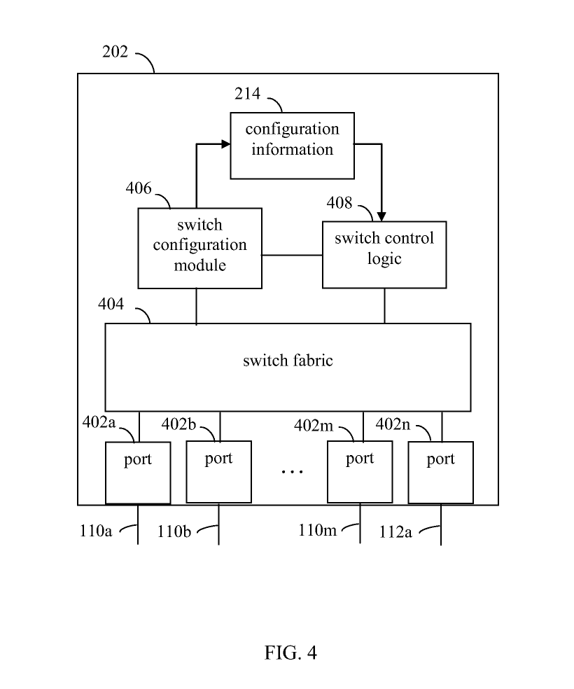

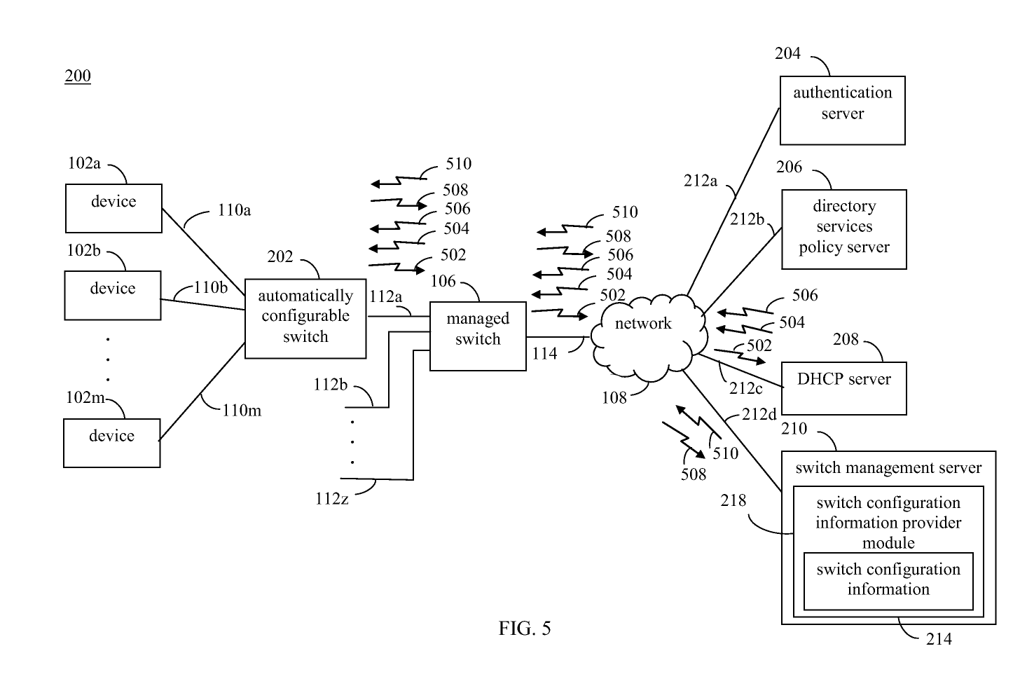

ACS 202 is self-configurable. For example, when ACS 202 is initially coupled into network 202, ACS 202 may be configured to communicate over network 202 to obtain configuration information, such as by communicating with one or more of managed switch 106, authentication server 204, directory services policy server 206, DHCP server 208, and/or switch management server 210. For example, FIG. 3 shows a flowchart 300 providing example steps for configuring a switch, such as ACS 202, according to an example embodiment of the present invention. Flowchart 300 is described with respect to FIGS. 4 and 5, for illustrative purposes. FIG. 4 shows a block diagram of ACS 202, according to an example embodiment of the present invention. In the embodiment of FIG. 4, ACS 202 includes a plurality of ports 402a-402n, a switch fabric 404, a switch configuration module 406, and switch control logic 408. FIG. 5 shows a block diagram illustrating communications in network 200 for configuring ACS 202 according to flowchart 300. Other structural and operational embodiments will be apparent to persons skilled in the relevant art(s) based on the discussion regarding flowchart 300. Flowchart 300 is described as follows.

Flowchart 300 begins with step 302. In step 302, communications over the network are enabled for the switch. For example, in an embodiment, ACS 202 may be enabled for communications over network 200 by connecting ACS 202 into network 200. ACS 202 may be coupled into network 200 by coupling devices 102a-102m into ports of ACS 202 using links 110a-110m, and coupling managed switch 106 into a port of ACS 202 using link 112a. For instance, FIG. 4 shows communication links 110a-110m coupled to ports 402a-402m, and communication link 112a coupled to port 402n of ACS 202. ACS 202 may be powered up to begin functioning. After power up, communication traffic may be received at one or more of ports 402.

In ACS 202, switch fabric 404 is coupled to ports 402a-402n. Switch fabric 404 includes hardware, software, and/or firmware configured to transfer data received at one of ports 402a-402n to one or more of ports 402a-402n for transmit from ACS 202. For example, switch fabric 404 may include one or more data buffers, memory/storage, an interconnection network, and/or other components/features. Switch fabric 404 functions under the control of switch control logic 408, which is the primary control logic for ACS 202. For example, switch control logic 408 may be configured to analyze a physical device (e.g., Media Access Control or MAC) address in each incoming data packet, and to instruct switch fabric 404 to forward the data packet to one or more of ports 402a-402n based on the physical device address.

In step 304, a request is transmitted over the network for a network address for the switch. Switch configuration module 406 is configured to obtain configuration information for ACS 202. Switch control logic 408 may instruct to switch configuration module 406 to initiate configuration of ACS 202 after ACS 202 is enabled for communications. Switch configuration module 406 may generate a request for a network address. The request may be transmitted to a remote device configured to provide a network address, such as DHCP server 208 shown in FIG. 5. As shown in FIG. 4, the generated request may be transmitted from module 406 through switch fabric 404 to ports 402a-402n to be transmitted from ACS 202. In embodiments, the generated request may be transmitted from all of ports 402a-402n (because location of the remote device is not known), or from a designated one of ports 402a-402n (e.g., port 402n coupled to DHCP server 208). For instance, as shown in FIG. 5, a network address request signal 502 is transmitted from ACS 202 on communication link 112a, which is received by DHCP server 208 through managed switch 106, communication link 114, network 108, and communication link 212c.

In step 306, the network address is received for the switch over the network. For instance, in the example of FIG. 5, DHCP server 208 generates a network address, such as an internet protocol (IP) address, for ACS 202. DHCP 208 generates the network address in a manner well known by persons skilled in the relevant art(s). As shown in FIG. 5, DHCP 208 generates and transmits a response signal 504 that includes the generated network address, which is received by ACS 202 through communication link 212c, network 108, communication link 114, managed switch 106, and communication link 112a. The received network address is stored in ACS 202.

In step 308, a network address is received for a switch management server over the network. As shown in FIG. 5, DHCP 208 generates and transmits a signal 506 that includes the network address for switch management server 210. In an embodiment, DHCP server 208 (or other server) is configured to transmit the network address for switch management server 210 to ACS 202 in response to receiving network address request signal 502 (in step 304). Alternatively, ACS 202 may transmit a separate request signal (not shown in FIG. 5) to DHCP server 208 (or other server) requesting the network address for switch management server 210. The received network address for switch management server 210 is stored in ACS 202.

In step 310, a request is transmitted over the network to the switch management server for switch configuration information. In an embodiment, switch configuration module 406 generates a request for configuration information for ACS 202. The generated request may be transmitted from module 406 through switch fabric 404 to ports 402a-402n to be transmitted from ACS 202. For example, as shown in FIG. 5, a configuration information request signal 508 is transmitted from ACS 202 to switch management server 210 through communication link 112a, managed switch 106, communication link 114, network 108, and communication link 212d.

In step 312, the configuration information is received from the switch management server entity over the network. Switch management server 210 stores switch configuration information 214. Switch configuration information 214 includes one or more configuration settings and/or other information that may be used to configure functionality of ACS 202. Examples of configuration information 214 are described in detail further below. In an embodiment, switch management server 210 may include a switch configuration information provider module 218, configured to receive request signal 508, and to transmit configuration information 214 to the requesting network switch. Switch configuration information provider module 218 may be implemented in hardware, software, firmware, or any combination thereof. A system administrator may interact with server 210 to provide/configure configuration information 214 to be provided to ACS 202 and to further such switches by switch configuration information provider module 218. For example, server 210 may have a Web interface or other type of interface for a system administrator.

As shown in FIG. 5, in response to request signal 508, switch management server 210 transmits a response signal 510 that includes configuration information 214, which is received by ACS 202 through communication link 212d, network 108, communication link 114, managed switch 106, and communication link 112a. Configuration information 214 is stored in ACS 202.

In the example of FIG. 5, switch management server 210 is a stand-alone server. In alternative embodiments, switch management server 210 may be combined with one or more of authentication server 204, directory services policy server 206, and DHCP server 208. In embodiments, authentication server 204, directory services policy server 206, and DHCP server 208 may be stand alone servers, or may be combined in any manner.

In step 314, one or more features of the switch are configured according to the received configuration information. For example, as shown in FIG. 4, switch control logic 408 receives configuration information 214. Configurable functions/features of switch control logic 408 are configured by configuration information 214, such as by assigning settings, options, or other configurable functions/features of ACS 202 that are controlled by switch control logic 408 with values provided by configuration information 214.

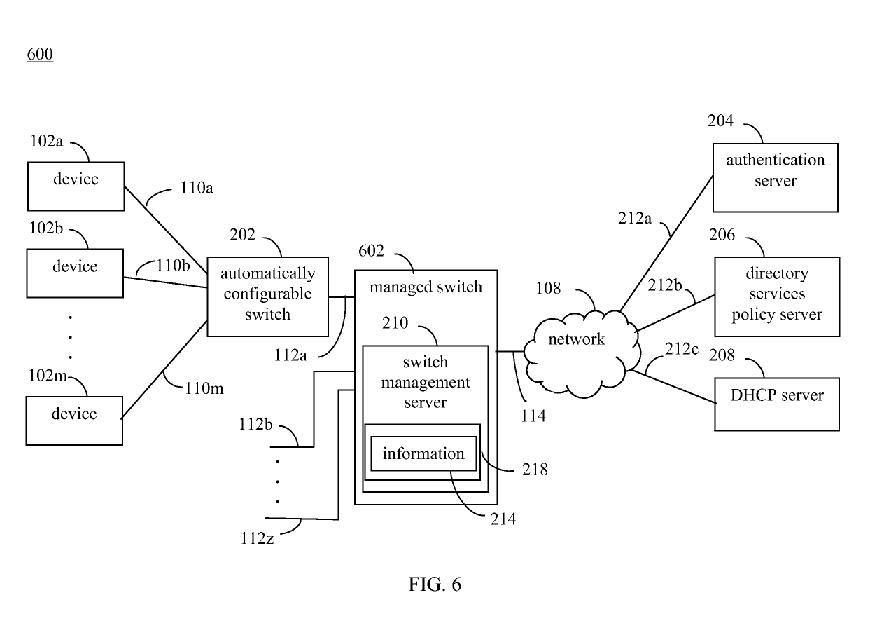

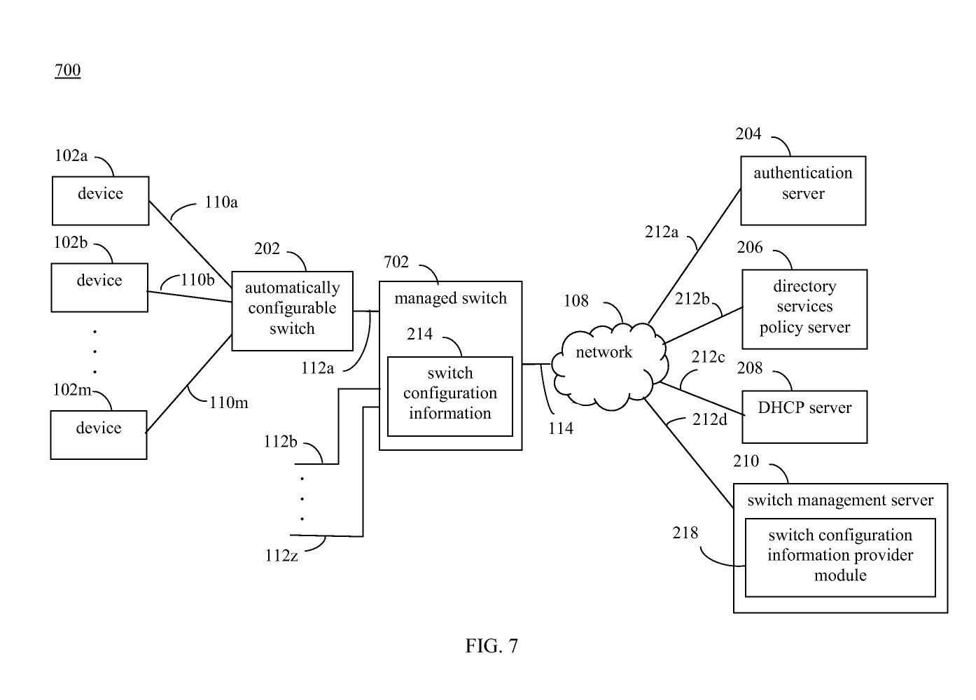

FIGS. 6 and 7 show computer networks 600 and 700, respectively, having further example configurations for switch management server 210, according to further example embodiments of the present invention. In the embodiment of FIG. 6, switch management server 210 is integrated in a managed switch 602, and thus flowchart 300 shown in FIG. 3 may be adapted to communicating with switch management server 210 in managed switch 106. In the embodiment of FIG. 7, a managed switch 702 stores configuration information 214. Switch management server 210 is separate from managed switch 702, and generates switch configuration information 214. Switch configuration information 214 is transmitted from server 210 to managed switch 702, to be maintained at managed switch 702. Thus, flowchart 300 may be adapted such that in step 312, the configuration information is received by ACS 202 from managed switch 702, rather than directly from switch management server 210.

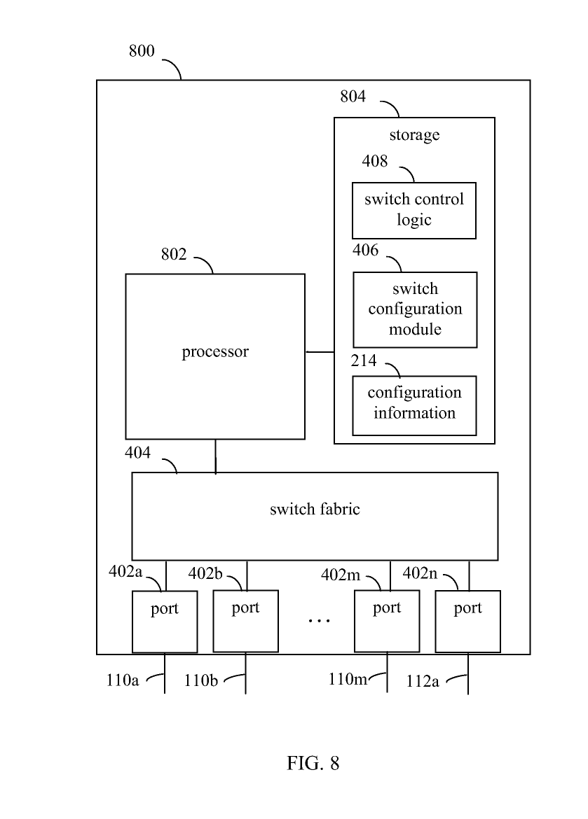

Switch configuration module 406 and switch control logic 408 shown in FIG. 4 may be implemented in ACS 202 in hardware, software, firmware, or any combination thereof. For example, FIG. 8 shows a block diagram of an ACS 800, which is an example of ACS 202 shown in FIG. 2, according to an example embodiment of the present invention. As shown in FIG. 8, ACS 800 includes ports 402a-402n, switch fabric 404, a processor 802, and storage 804. In FIG. 8, switch control logic 408 and switch configuration module 406 are stored in storage 804 as software code that is accessible and executable by processor 802. Configuration information 214 obtained from switch management server 210 is stored in storage 804. In embodiments, processor 802 may be any type of processor, microprocessor, microcontroller, computing logic, central processing unit (CPU), or combination thereof, including an ARM core processor, a processor distributed by Intel Corporation, combinatorial logic, or any other make or type of processor. Storage 804 may be any type of storage, including one or more memory chips (e.g., static random access memory (SRAM), dynamic RAM, etc.), hard disc drives, optical drives, etc.

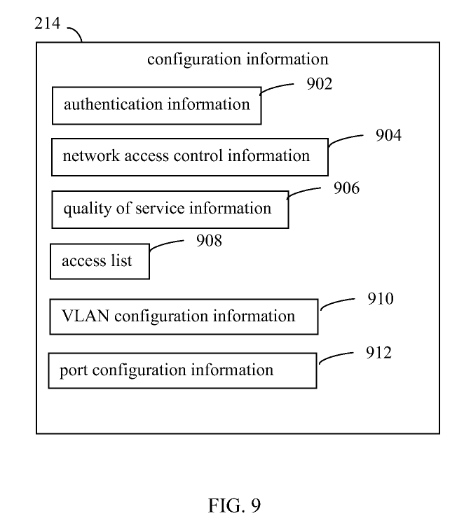

In embodiments, configuration information 214 includes configuration settings, options, and/or values that may be assigned to configurable functions/features of ACS 202. For instance, FIG. 9 shows example entries for configuration information 214, according to an embodiment of the present invention. The entries shown for configuration information 214 in FIG. 9 are not intended to be exhaustive, but are provided for illustrative purposes. Further configurable functions/features for ACS 202 will be apparent to persons skilled in the relevant art(s) from the teachings herein, such as those that may be known or future developed with regard to managed switches.

As shown in FIG. 9, configuration information 214 includes authentication information 902, network access control (NAC) information 904, quality of service (QOS) information 906, an access list 908, and VLAN configuration information 910. Any one or more of authentication information 902, NAC information 904, QOS information 906, access list 908, VLAN configuration information 910, and port configuration information 912 may be present in configuration information 214 in embodiments. Authentication information 902, NAC information 904, QOS information 906, access list 908, VLAN configuration information 910, and port configuration information 912 are described as follows.

Authentication information 902 may include one or more authentication settings. For example, authentication information 902 may include a network address for an authentication server, such as authentication server 204. The network address may be used by ACS 202 to identify authentication server 204, so that ACS 202 can undertake communications with authentication server 204 over a network (e.g., network 200, 600, or 700). ACS 202 may communicate with authentication server 204 to authenticate port-coupled devices (e.g., devices 102a-102m) that couple to ports 402 of ACS 202. Such authentication may occur according to the IEEE 802.11X standard, according to another standard, or according to any other authentication process. In an embodiment, authentication server 204 may be a RADIUS (remote authentication dial in user service) server or other type of authenticating server. ACS 202 may receive security credentials, such as a username and password, from a port-coupled device, and transmit the credentials to authentication server 204 for authentication (e.g., according to authentication schemes such as PAP (password authentication protocol), CHAP (challenge handshake authentication protocol), or EAP (extensible authentication protocol)). If the port-coupled device is authenticated, authentication server 204 transmits an authentication indication to ACS 202 to be provided to the port-coupled device. If the port-connected device is not authenticated, authentication server 204 provides a non-authenticated indication to ACS 202, and ACS 202 may block communications at the port 402 to which the device is coupled.

Authentication information 902 may include a password and/or other security credentials for ACS 202 to perform communications with the authentication server 204. Authentication information 902 may include a default level of access to the network for a device coupled to a port 402 of ACS 202. For example, the default level of access may indicate whether or not a device coupled to a port of ACS 202 must be authenticated prior to network communications, and/or indicate particular communications and/or network features to be accessible by the port-coupled device by default (e.g., in an authenticated or non-authenticated condition).

NAC information 904 may include information that reflects policies for securing devices coupled to ACS 202 prior to allowing such devices to access the network (e.g., for performing posture assessment/compliance checking). NAC information 904 may include information indicating particular settings for devices coupled to ports 402 of ACS 202 (e.g., Windows™ registry settings). NAC information 904 may indicate one or more security constraints to be satisfied by a device coupled to a port 402 of ACS 202 prior to communications over the network by the device. For example, NAC 904 may provide information enabling ACS 202 to verify whether a port-coupled device has desired anti-virus protection, desired software (e.g., operating system), recent software patches, a personal firewall, etc., prior to enabling the device to communicate over the network.

QOS information 906 may include information for reserving/prioritizing resources of ACS 202. For example, QOS information 906 may include information for prioritizing resources by user (e.g., by username) and/or by device 102, for prioritizing ports 402, for prioritizing applications (e.g., multimedia applications), or for prioritizing in other ways. In an example embodiment, QOS information 906 may include priority information prioritizing communications over a particular port 402 of ACS 202 higher than communications over other ports of ACS 202 based on the QOS information. For example, a particular port 402 may be known to have more data traffic, and/or to have more important data traffic, than other ports 402 of ACS 202, and thus may be assigned a higher priority for network communications. For example, an IP telephone (voice over IP) or an IP television device may be coupled to the port, and thus the port may be assigned a higher priority to enable the highest possible voice and/or video quality. In another embodiment, QOS information 906 may include priority information prioritizing communications containing information of a first type higher than communications containing information of one or more other types based on the QOS information. For instance, communications including voice data or video data may be prioritized more highly than other information types, to enable the highest possible voice and/or video quality.

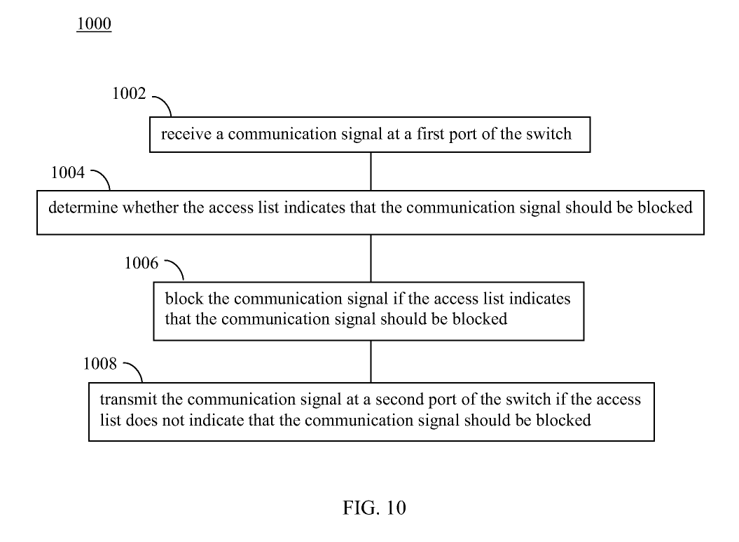

Access list 908 may include a list of applications, devices, users, ports, etc., that are authorized for communications on the network and/or are to be blocked from communications on the network. FIG. 10 shows a flowchart 1000 providing example steps for enabling a communication signal according to an access list, according to an embodiment of the present invention. ACS 202 may perform flowchart 1000 with regard to a communication signal received at a port 402 to determine whether the communication signal should be transmitted or blocked. Flowchart 1000 is described as follows.

In step 1002 of flowchart 1000, a communication signal is received at a first port of the switch. For example, a communication signal may be received at port 402b of ACS 202.

In step 1004, it is determined whether the access list indicates that the communication signal should be blocked. The communication signal can be analyzed to determine whether it is from a user (e.g., a username), a device (e.g., one of devices 102 listed by network address), or a port 402 of ACS 202 listed in access list 908 to be blocked, or contains information related to an application listed in access list 908 for blocking.

In step 1006, the communication signal is blocked if the access list indicates that the communication signal should be blocked. If access list 908 lists the user, device, application, and/or port 402 for blocking, the communication signal is blocked (e.g., is not transmitted from ACS 202).

In step 1008, the communication signal is transmitted at a second port of the switch if the access list does not indicate that the communication signal should be blocked. If access list 908 does not list the user, device, application, and/or port 402 for blocking, the communication signal is transmitted from ACS 202. For example, the communication signal may be transmitted from one or more of ports 402a-402n, as appropriate for the particular signal.

In an embodiment, as described above, ACS 202 may receive access list 908 in configuration information 214. In another embodiment, configuration information 214 may include a network address for directory services policy server 206. Directory services policy server 206 may be a server that executes a directory service application that stores/organizes information about the network's users and/or resources. For example, directory policy server 206 may be configured to execute a directory services protocol such as LDAP (lightweight directory access protocol) or AD (active directory). ACS 202 may obtain access list 908 from directory services policy server 206. ACS 202 may obtain access list 908 from directory services policy server 206 immediately after receiving configuration information 214 from switch management server 210, and/or may obtain access list 908 from directory services policy server 206 from time-to-time when needed. For example, ACS 202 may receive a communication signal at a port 402 from a device which is not known by ACS 202 to be authorized for communications on the network. After receiving the communication signal, ACS 202 may communicate with directory services policy server 206 to determine whether the device is authorized for communications, and directory services policy server 206 may transmit access list 908 to ACS 202, indicating whether the device is authorized for communications. In one embodiment, the policy information can be obtained from authentication server 204, or authentication server 204 and policy server 206 may be combined as one server.

VLAN configuration information 910 may include information for configuring ACS 202 to accommodate one or more VLANs present in the network. For example, VLAN configuration information 910 may list one or more VLANs (e.g., by VLAN identification number and/or VLAN name) in which ACS 202 is included, may list one or more other switches included in each VLAN, one or more ports 402 included in each VLAN, and/or additional VLAN configuration information.

Port configuration information 912 may include port settings including but not limited to speed, duplex, negotiation settings, name, a VLAN that the port may be assigned to (e.g., statically, dynamically, or through policy), etc.

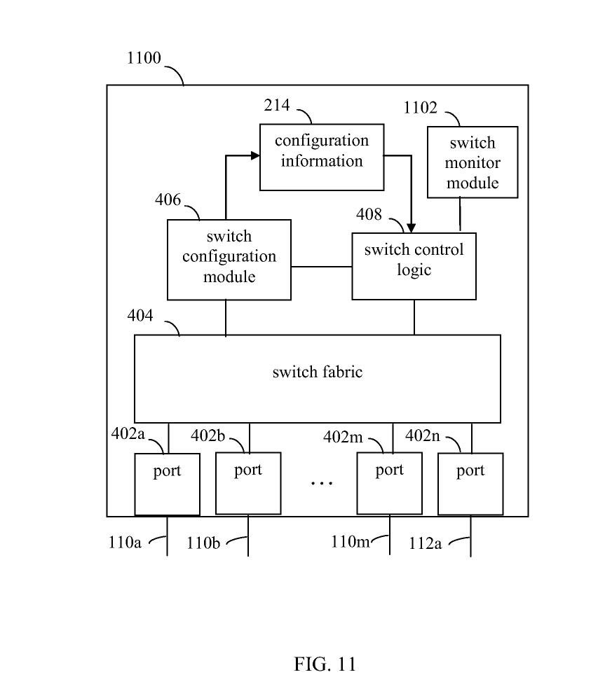

In an embodiment, ACS 202 may have monitor functionality, similar to that of conventional managed switches (e.g., managed switch 106), but not present in unmanaged switches (e.g., unmanaged switch 104 of FIG. 1). For example, FIG. 11 shows a block diagram of an ACS 1100, which is an example of ACS 202 shown in FIG. 2, according to an example embodiment of the present invention. As shown in FIG. 11, ACS 1100 is similar to ACS 202 shown in FIG. 4, with the addition of a switch monitor module 1102. Switch monitor module 1102 is configured to perform monitor functions for ACS 1100 to determine a status of ACS 1100 and/or communications handled by ACS 1100. Such monitor functions, and implementations for the same, are known to persons skilled in the relevant art(s). Switch monitor module 1102 may be implemented in hardware, software, firmware, or any combination thereof. Example monitoring functions that may be performed by switch monitor module 1102 include providing data rates, numbers of data packets, data packet sizes, port-specific information, and/or further monitoring functions. The resulting monitor data can be viewed/analyzed by a system administrator using a Web or other interface coupled to ACS 202, can be transmitted from ACS 202 to another server (e.g., one or more of the servers in FIG. 2), and/or may be otherwise processed and/or utilized. In an embodiment, switch monitor module 1102 may store data generated/collected by module 1102 in storage of ACS 1100 (e.g., storage 804 shown in FIG. 8).

Note that as described above, some embodiments may be implemented as software/firmware. For example, devices 102, automatically configurable switches 202, 800, 1100, managed switches 106, 602, 702, and/or servers 204, 206, 208, 210 may include software and/or firmware configured to perform some or all of their respective functions described herein. Any apparatus or manufacture comprising a computer useable or readable medium having control logic (software) stored therein is referred to herein as a computer program product or program storage device. Such computer program products, having control logic stored therein that, when executed by one or more devices, switches, and or servers, cause such devices, switches, and/or servers to operate as described herein, represent embodiments of the invention.

The invention can work with software, hardware, and/or operating system implementations other than those described herein. Any software, hardware, and operating system implementations suitable for performing the functions described herein can be used.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method in a switch for interfacing with a network, comprising:
transmitting a request over the network for a network address for the switch;
receiving the network address for the switch over the network;
receiving a network address for a switch management server over the network;
transmitting a request over the network to the switch management server for switch configuration information;
receiving the configuration information from the switch management server entity over the network; and
configuring one or more features of the switch according to the received configuration information.

2. The method of claim 1, wherein the configuration information includes at least one authentication setting, wherein said receiving the configuration information comprises:
receiving the at least one authentication setting, wherein the at least one authentication setting includes one or more of a network address for an authentication server, a password for communications with the authentication server, a default level of access to the network for a device coupled to a port of the switch, or an indication of whether authentication is required for a device coupled to a port of the switch.

3. The method of claim 1, wherein the configuration information includes network access control (NAC) information, wherein said receiving the configuration information comprises:
receiving the NAC information, wherein the NAC information indicates one or more security constraints to be satisfied by a device coupled to a port of the switch prior to communications over the network by the device.

4. The method of claim 1, wherein the configuration information includes quality of service (QOS) information, wherein said configuring one or more features of the switch according to the received configuration information comprises:
prioritizing communications over a port of the switch higher than communications over other ports of the switch based on the QOS information.

5. The method of claim 1, wherein the configuration information includes quality of service (QOS) information, wherein said configuring one or more features of the switch according to the received configuration information comprises:
prioritizing communications containing information of a first type higher than communications containing information of one or more other types based on the QOS information.

6. The method of claim 1, wherein the configuration information includes an access list, the method further comprising:
receiving a communication signal at a first port of the switch;
determining whether the access list indicates that the communication signal should be blocked;
blocking the communication signal if the access list indicates that the communication signal should be blocked; and
transmitting the communication signal at a second port of the switch if the access list does not indicate that the communication signal should be blocked.

7. The method of claim 6, wherein said determining whether the access list indicates that the communication signal should be blocked comprises:
determining whether at least one of an application related to the communication signal, a network address of a sending device of the communication signal, a user associated with the communication signal, or the second port are indicated as blocked in the access list.

8. The method of claim 1, wherein the configuration information includes virtual local area network (VLAN) configuration information, wherein said receiving the configuration information comprises:
receiving the VLAN configuration information.

9. The method of claim 1, wherein the configuration information includes port configuration information, wherein said receiving the configuration information comprises:
receiving the port configuration information.

10. The method of claim 1, further comprising:
monitoring a status of communication traffic handled by the switch.

11. A method in a server coupled to a network, comprising:
receiving a request from a switch for configuration information; and
transmitting the configuration information to the switch;
whereby the switch receives the transmitted configuration information and configures one or more switch features according to the received configuration information.

12. The method of claim 11, wherein the configuration information includes at least one of authentication information, network access control (NAC) information, quality of service (QOS) information, access list information, virtual local area network (VLAN) information, or port configuration information.

13. A network switch, comprising:
a plurality of ports configured to be coupled to a plurality of network communication links;
a switch fabric coupled to each of the plurality of ports;
a switch control logic coupled to the switch fabric; and
a switch configuration module coupled to the switch control logic;
wherein the switch configuration module is configured to generate a request to be transmitted from a port over the network for a network address for the network switch and a network address for a switch management server;
wherein the switch configuration module is configured to generate request to be transmitted from a port over the network to the switch management server for switch configuration information; and
wherein the switch control logic is configured to configure one or more features of the network switch according to the received configuration information.

14. The network switch of claim 13, wherein the configuration information includes authentication information, wherein the authentication information includes one or more of a network address for an authentication server, a password for communications with the authentication server, a default level of access to the network for a device coupled to a port of the network switch, or an indication of whether authentication is required for a device coupled to a port of the network switch.

15. The network switch of claim 13, wherein the configuration information includes network access control (NAC) information, wherein the NAC information indicates one or more security constraints to be satisfied by a device coupled to a port of the network switch prior to communications over the network by the device.

16. The network switch of claim 13, wherein the configuration information includes quality of service (QOS) information, wherein the switch control logic is configured to prioritize communications over a port of the network switch higher than communications over other ports of the network switch based on the QOS information.

17. The network switch of claim 13, wherein the configuration information includes quality of service (QOS) information, wherein the switch control logic is configured to prioritize communications containing information of a first type higher than communications containing information of one or more other types based on the QOS information.

18. The network switch of claim 13, wherein the configuration information includes an access list, wherein the network switch is configured to block a received communication signal if the access list indicates that the communication signal should be blocked.

19. The network switch of claim 18, wherein the network switch is configured to block the received communication signal if the network switch control logic determines that at least one of an application related to the communication signal, a network address of a sending device of the communication signal, a user associated with the communication signal, or a port associated with the received communication signal is indicated as blocked in the access list.

20. The network switch of claim 13, wherein the configuration information includes virtual local area network (VLAN) configuration information.

21. The network switch of claim 13, wherein the configuration information includes port configuration information.

22. The network switch of claim 13, further comprising:
a switch monitor module configured to monitor a status of communication traffic handled by the network switch.

23. A server coupled to a network, comprising:
switch configuration information provider module configured to receive a request from a switch for configuration information, and to transmit the configuration information to the switch;
whereby the switch receives the transmitted configuration information and configures one or more switch features according to the received configuration information.

24. The server of claim 23, wherein the configuration information includes at least one of authentication information, network access control (NAC) information, quality of service (QOS) information, access list information, virtual local area network (VLAN) information, or port configuration information.
